(19) United States
(12) Patent Application Publication
(10) Pub. No.: US 2025/0181927 A1
(43) Pub. Date: Jun. 5, 2025

(54) METHOD FOR LOCATING AT LEAST ONE ANOMALY IN A SPATIO-TEMPORAL PIECE OF DATA

(71) Applicant: AIRBUS DS SLC, ELANCOURT (FR)

(72) Inventors: Abhishek DJEACHANDRANE, CREPY-EN-VALOIS (FR); Serge DELMAS, SAINT-REMY-L'HONORE (FR); Alain DUBOIS, SAINT-REMY LES CHEVREUSE (FR); Abdelhamid MELLOUK, ORSAY (FR)

(21) Appl. No.: 18/968,333

(22) Filed: Dec. 4, 2024

(30) Foreign Application Priority Data
Dec. 5, 2023 (FR) 2313545

(51) Int. Cl. G06N 3/092

(52) U.S. Cl. CPC G06N 3/092

(57) ABSTRACT

A method for locating at least one anomaly in a spatio-temporal piece of data includes obtaining a spatio-temporal piece of data, obtaining a neural network configured to generate a piece of information of locating at least one anomaly from a spatio-temporal piece of data, generating, by the neural network obtained, the piece of information of locating the at least one anomaly by providing the spatio-temporal piece of data obtained to the neural network, obtaining an accuracy score provided by a user evaluating an accuracy of the generated piece of information of locating the at least one anomaly, reinforcement learning the neural network, and similarity learning the neural network reinforcement learned.

### CROSS-REFERENCE TO RELATED APPLICATIONS

This application claims priority to French Patent Application No. 2313545, filed Dec. 5, 2023, the entire content of which is incorporated herein by reference in its entirety.

### FIELD

The technical field of the invention is that of locating anomalies and in particular locating anomalies in a spatio-temporal piece of data.

This invention relates to a method for locating at least one anomaly in a spatio-temporal piece of data.

### BACKGROUND

Spatio-temporal data are data characterised by spatial attributes, such as distance and/or direction and/or position, and temporal attributes, such as number of occurrences of events and/or changes in time and/or a duration. In other words, spatio-temporal data are data that undergo change in time and space. These spatio-temporal data are, within the scope of the present application, generated by measuring a real environment. For example, a video from a video surveillance system is a spatio-temporal piece of data. Other spatio-temporal data compatible with the invention are, for example, data from a measurement of vibration and/or heat and/or a force exerted on a system, such as an aeroplane engine or wing.

Locating an anomaly in spatio-temporal data consists in identifying the possible presence of an irregularity within this spatio-temporal piece of data. The term “locating an anomaly” also comprises the case wherein no anomaly has been identified in the spatio-temporal piece of data. Locating can be temporally and/or spatially made within this piece of data. Temporally locating an anomaly consists in identifying the moment at which any anomaly is present in the spatio-temporal piece of data. For example, in a video captured by a video surveillance system lasting one minute, an anomaly may be detected at the 3rd or 20th second of the video. Spatially locating an anomaly consists in identifying the location of the at least one anomaly, i.e. the anomaly or anomalies, in all the data. For example, in a video captured by a multi-camera video surveillance system, an anomaly may be detected in the video from only one of the cameras in the video surveillance system. Locating an anomaly is therefore different from identifying the presence or absence of an anomaly.

The term “anomaly” describes in this application any irregularity that can be detected in a spatio-temporal piece of data. In the example of spatio-temporal piece of data from a video surveillance system, an anomaly may be one or more of the following events: an act of vandalism, an explosion, a riot, an accident, a person running or throwing an object. The anomaly or anomalies to be located can be predetermined, for example.

There are different methods in prior art for locating an anomaly in a spatio-temporal piece of data. It is known, for example, to use an automatic learning method based on a neural network. Thus, the neural network is trained beforehand on a set of annotated spatio-temporal data before being used in the production phase. Annotation consists in adding a piece of information of locating an anomaly for each spatio-temporal piece of data. Anomalies are therefore predetermined before starting the neural network training phase and each occurrence of an anomaly is located for each piece of data in the set of spatio-temporal data used for training. The production phase is the phase during which a previously trained neural network is used to perform an application task, for example, in the case of the invention, locating an anomaly in a spatio-temporal piece of data not included in the set of spatio-temporal data used for training.

A first problem relating to the use of methods of prior art is therefore the difficulty of obtaining annotated set of spatio-temporal data. Indeed, annotating a set of spatio-temporal data is a complex, time-consuming and costly task. It is to be noted that this is especially true when the annotation relates to temporally and/or spatially locating at least one anomaly in the spatio-temporal piece of data. Thus, it is easier to obtain a set of spatio-temporal data annotated with a piece of information about the presence and/or absence of an anomaly.

A second problem relating to methods of prior art is their inability to learn during the production phase. Thus, in methods of prior art, the neural network no longer learns during the production phase and cannot continue to improve its ability to locate anomalies during this phase.

A third problem relating to methods of prior art is their inability to adapt to new environments and/or to identify new types of anomaly during the production phase. In one example of a spatio-temporal piece of data which is a video from a video surveillance system, when the production phase of the neural network is performed in a new environment such as a new viewing angle for the video surveillance system camera(s), the neural network's ability to locate an anomaly is reduced. A “new environment” here means an environment not present in data used to train the neural network. Similarly, these methods of prior art cannot locate types of anomaly for which they have not been trained.

Thus there is a need to provide a method for locating an anomaly in a spatio-temporal piece of data which at least in partly limits problems relating to the use of methods of prior art.

### SUMMARY

An aspect of the invention offers a solution to the problems previously discussed, by providing reinforcement learning of the neural network during the production phase. Thus, the neural network is capable of learning during the production phase from previously unannotated spatio-temporal data. In addition, the method according to an aspect of the invention also allows similarity learning of the neural network during the production phase. The neural network is therefore able to quickly adapt to the location of an anomaly in a new environment and/or to the location of a new anomaly during the production phase.

A first aspect of the invention relates to a computer-implemented method for locating at least one anomaly in a spatio-temporal piece of data, the method comprising the steps of:
obtaining a spatio-temporal piece of data,
obtaining a neural network configured to generate a piece of information of locating at least one anomaly from a spatio-temporal piece of data,
generating, by the neural network obtained, the piece of information of locating the at least one anomaly by providing the spatio-temporal piece of data obtained to the neural network,
obtaining an accuracy score provided by a user evaluating an accuracy of the generated piece of information of locating the at least one anomaly,
reinforcement learning the neural network, from the generated piece of information of locating the at least one anomaly and from the accuracy score, reinforcement learning being performed from a first function penalising a low value of the accuracy score,
similarity learning the neural network reinforcement learned, from a first set of spatio-temporal data comprising the spatio-temporal piece of data obtained, similarity learning being performed from a second function to be minimised, the second function corresponding to a pairwise constraint between the spatio-temporal piece of data obtained and at least one other spatio-temporal piece of data of the first set of spatio-temporal data, the first set of spatio-temporal data comprising, for each spatio-temporal piece of data of the first set of spatio-temporal data, a ground truth piece of locating the at least one anomaly obtained from the generated piece of information of locating the at least one anomaly in the spatio-temporal piece of data and from the accuracy score.

By virtue of one or more aspects of the invention, it is possible to temporally and/or spatially locate an anomaly in a spatio-temporal piece of data. In addition, the method becomes increasingly efficient during the production phase because the neural network reinforcement learns by using user feedback evaluating accuracy of the location of the at least one anomaly provided by the neural network. In addition, the neural network is capable of adapting quickly to a new environment and/or detecting a new type of anomaly during the production phase.

Further to the characteristics just discussed in the preceding paragraph, the method according to the first aspect of the invention may have one or more additional characteristics from among the following, considered individually or in any technically possible combinations:
reinforcement learning the neural network comprises a Markov decision process based reinforcement learning sub-phase and a multi armed bandit reinforcement learning based multi-instance learning,
the Markov decision process based reinforcement learning sub-phase is performed from a third function reinforcing anticipated location of the at least one anomaly in the spatio-temporal piece of data,
the multi armed bandit reinforcement learning based multi-instance learning is performed from a fourth function reinforcing multiple location of the at least one anomaly in the spatio-temporal piece of data, and
the spatio-temporal piece of data is:
   a video, and/or
   a sound, and/or
   a piece of data derived from a measurement of force and/or vibration and/or temperature and/or pressure and/or brightness.

A second aspect of the invention relates to a method for initially learning a neural network taking as an input a spatio-temporal piece of data and providing as an output a piece of information of locating at least one anomaly in said spatio-temporal piece of data, the method comprising steps of:
reinforcement learning the neural network, from a second set of weakly annotated spatio-temporal data, each spatio-temporal piece of data of the second set of spatio-temporal data being annotated with a ground truth piece of information of the presence and/or absence of the at least one anomaly in said each spatio-temporal piece of data, reinforcement learning the neural network being performed from a fifth function penalising a difference, for each spatio-temporal piece of data of the second set of spatio-temporal data, between the generated piece of information of locating the at least one anomaly for said each spatio-temporal piece of data generated by the neural network and the a ground truth piece of information of said each spatio-temporal piece of data,
generating, from the second set of spatio-temporal data, sub-sets of spatio-temporal data, each sub-set of spatio-temporal data comprising at least one spatio-temporal piece of data with at least one anomaly and at least one spatio-temporal piece of data with no anomaly, and
similarity learning the neural network, for each spatio-temporal piece of data of each subset of spatio-temporal data, similarity learning the neural network from a sixth function penalising a pairwise constraint between said each spatio-temporal piece of data and at least one other spatio-temporal piece of data of said each subset of spatio-temporal data.

In the method according to the second aspect of the invention, the spatio-temporal piece of data is:
a video, and/or
a sound, and/or
a piece of data derived from a measurement of force and/or vibration and/or temperature and/or pressure and/or brightness.

In the method according to the first aspect of the invention, obtaining the neural network comprises initially training the neural network according to the second aspect of the invention

A third aspect of the invention relates to a non-transitory computer program product comprising instructions which, when the program is executed by a computer, cause the same to implement the method according to the invention.

A fourth aspect of the invention relates to a non-transitory computer-readable recording medium comprising instructions which, when executed by a computer, cause the same to implement the method according to the invention.

A fifth aspect of the invention relates to a system comprising a device adapted to perform the method according to the invention.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 is a block diagram illustrating the steps of one example method 100 according to the invention.

FIG. 2 is a block diagram illustrating the sub-steps of a step 170 of one example method 100 according to the invention.

FIG. 3 is a schematic representation of one example method 100 according to the invention.

FIG. 4 is a block diagram illustrating the steps of one example method 200 according to the invention

### DETAILED DESCRIPTION

Unless otherwise specified, a same element appearing in different figures has a single reference.

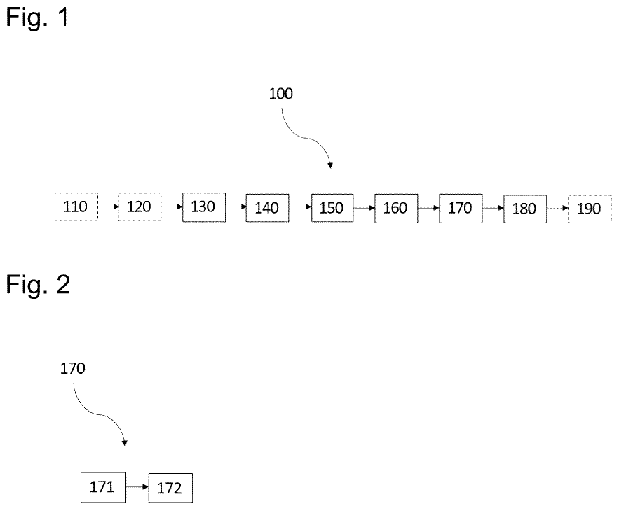

FIG. 1 is a block diagram illustrating the steps of one example method 100 according to the invention. The mandatory steps of the example method 100 are indicated by a solid rectangle and the optional steps are indicated by a dotted rectangle.

The method 100 is implemented by computer. By “computer-implemented”, it is meant that the steps, or substantially all of the steps, are executed by at least one computer or processor or other similar system, or a distributed system of interconnected processors. This includes general-purpose computers, specialized hardware configurations, cloud-based infrastructures, or combinations thereof. The computer may consist of one or more processing units, memory storage devices, and communication interfaces that work in concert to facilitate the execution of the method. These components are configured to process spatio-temporal data, execute neural network operations, and manage reinforcement and similarity learning modules. Thus, some steps are performed by the computer, possibly fully automatically, or semi-automatically. In examples, at least some of the steps of these methods may be triggered by user-computer interaction. For example, step 160 may be performed by user-computer interaction. The level of user-computer interaction required may depend on the level of automation intended and balanced against the need to implement the user's desires. In examples, this level may be user-defined and/or pre-defined. The computer system may further be equipped with a graphical user interface (GUI) or command-line interface (CLI) to facilitate interaction with end-users. The GUI may enable users to visualize anomaly locations, provide feedback on detection accuracy, or adjust operational parameters dynamically. Data storage and retrieval functionalities are supported by a database or distributed ledger system that ensures efficient handling of large datasets while maintaining data integrity.

A typical example of computer implementation of a method is to execute the method with a system adapted to that end. The system may comprise a processor coupled to a memory and a Graphical User Interface (GUI), the memory having stored thereon a computer program comprising instructions for implementing the method. The memory may also store a database. The memory is any hardware adapted for such storage, possibly comprising a plurality of distinct physical parts.

The method 100 is a method for locating an anomaly in a spatio-temporal piece of data. Thus, the method 100 not only makes it possible to know whether a spatio-temporal piece of data comprises one or more anomalies, but the method 100 also makes it possible, when the spatio-temporal piece of data is abnormal, to provide at least one spatial and/or temporal piece of information for locating the anomaly or anomalies in the spatio-temporal piece of data. In the present application, a spatio-temporal piece of data is referred to as “abnormal spatio-temporal piece of data” when it comprises one or more anomalies and as “normal spatio-temporal piece of data” when it comprises no anomaly.

The method 100 according to an embodiment of the invention may comprise an optional first step 110 of dividing the spatio-temporal piece of data into data segments, each segment being a part of the spatio-temporal piece of data. Dividing the spatio-temporal piece of data makes it possible to obtain temporally contiguous segments of the spatio-temporal piece of data. For example, a video of 32 seconds divided into 32 segments can have the 1st second of the video as the first segment, the 2nd second of the video as the second segment and the 32nd second of the video as the 32nd segment. Complementarily or alternatively, the method 100 according to the invention may comprise an optional second step 120 of compressing the spatio-temporal piece of data, or each segment of the spatio-temporal piece of data, and extracting spatio-temporal characteristics. Extracting spatio-temporal characteristics can therefore be performed per spatio-temporal piece of data, i.e. an extraction is performed for each spatio-temporal piece of data separately, or per data segment, i.e. an extraction is performed for each spatio-temporal data segment separately. This step 120 can be performed using a pre-trained 3D convolutional neural network, noted C3D, or 3D ConvNet.

A third step 130 of the method 100 comprises obtaining a spatio-temporal piece of data. The term “obtaining” in this application corresponds to receiving and/or generating and/or calculating. For example, step 130 may comprise receiving a spatio-temporal piece of data. Alternatively, step 130 may comprise a step of generating the spatio-temporal piece of data, for example from different temporal data. For example, generating the spatio-temporal piece of data may consist in gathering different temporal data from measurements taken by different measurement apparatuses. The spatio-temporal piece of data obtained may come from a measurement of a real environment in which one or more anomalies may occur. For example, the spatio-temporal piece of data may come from a measurement taken in a factory and/or enable one or more anomalies relating to the manufacture and/or maintenance of at least one part of an aircraft to be detected. In another example, the spatio-temporal piece of data may be derived from a measurement taken in a place where at least one person is present and/or enables one or more anomalies relating to the behaviour and/or health of this at least one person to be detected.

In a first example, the spatio-temporal piece of data is a video. For example, a video from a video surveillance system comprising one or more cameras. Thus, all the videos from the different cameras can be synchronised in time and assembled to form a single video only. In a second example, the spatio-temporal piece of data is sound. As with the video, the sound can be the superimposition of several sound recordings made by different measurement apparatuses. In a third example, the spatio-temporal piece of data is derived from a measurement of force and/or vibration and/or temperature and/or pressure and/or brightness. In a fourth example, the spatio-temporal data comes from an electroencephalography apparatus. Electroencephalography (EEG) is a cerebral exploration method which measures electrical activity of the brain using electrodes placed on the scalp, often represented in the form of a trace called an electroencephalogram. Thus, spatially locating at least one anomaly can consist in identifying the electrode or electrodes, from among all the electrodes used, which provided the sub-part of the spatio-temporal data in which the at least one anomaly was located. Temporally locating may consist in identifying start and end of the at least one anomaly. In a fifth example, the spatio-temporal piece of data comes from a plurality of electrocardiogramaphy (ECG) is a graphical representation of electrical activity of the heart. In this example, the spatial location of at least one anomaly may consist in identifying the ECG apparatus or apparatuses, from among all the apparatuses used for example for a multitude of patients, which provided the sub-part of the spatio-temporal piece of data in which the at least one anomaly has been located.

More generally, the spatio-temporal piece of data may be derived from a measurement in one of the following sectors: aeronautics and/or naval and/or defence and/or civil and/or automotive and/or health and/or energy and/or motorway and/or tunnel and/or building and/or transport and/or vehicle fleet. For example, the method 100 makes it possible to locate anomalies in a navigation system and/or a fuel circuit and/or a self-piloting system and/or a communication system and/or a system of safety members and/or a train switch and/or a signalling system and/or smoke extractors in a tunnel and/or an energy distribution circuit and/or a transport logistics system and/or a home automation system in a building.

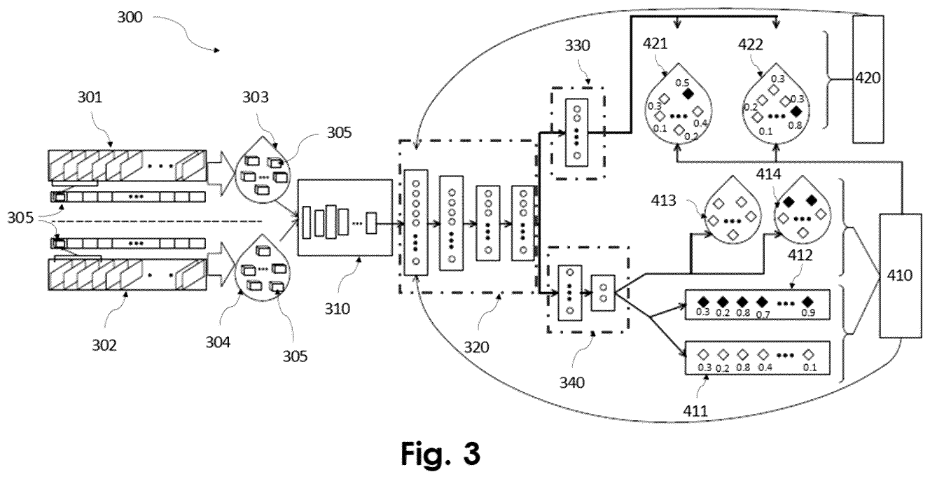

A fourth step 140 of the method 100 comprises obtaining a neural network. The neural network is configured to generate a piece of information of locating an anomaly from a spatio-temporal piece of data. The neural network may, for example, have been previously trained to locate one or more anomalies. A neural network compatible with the invention is, for example, a neural network of the multilayer perceptron type or any neural network with memory, such as a recurrent neural network, or a neural network used in the field of vision, such as a convolutional neural network, or a neural network comprising attention mechanisms. For example, FIG. 3 shows one example of a neural network 300 taking as an input a set of abnormal spatio-temporal data 301 and a set of normal spatio-temporal data 302. Each spatio-temporal piece of data 301 or 302 is divided into data segments 305, for example 12 segments 305. These data segments 305 are then gathered into sets of abnormal 303 and normal 304 segments, known as “bags”. These sets of segments 303 and 304 can then be provided to an element 310, such as a pre-trained 3D convolutional neural network, adapted to compress spatio-temporal data and extract spatio-temporal characteristics from the spatio-temporal data. The example neural network 300 illustrated in FIG. 3 comprises:
a first group 320, illustrated in FIG. 3 by a rectangle with a dashed line, of four neural network layers comprising for example 4096, 512, 256 and 256 neurons respectively, the first group 320 taking as an input the spatio-temporal piece of data obtained in step 130, optionally divided in step 110 and compressed in step 120, and providing as an output a compressed version of the spatio-temporal piece of data,
a second group 330, illustrated in FIG. 3 by a rectangle with a dashed line, of a neural network layer comprising for example respectively 128 neurons, the second group 330 taking as an input the output provided by the first group 320 and providing as an output a compressed version 422 of normal spatio-temporal data or segments of normal spatio-temporal data, i.e. comprising no anomaly, and a compressed version 421 of abnormal spatio-temporal data or segments of abnormal spatio-temporal data, i.e. comprising at least one anomaly, the compressed versions 421 and 422 comprising for each spatio-temporal piece of data or segment a score of locating at least one anomaly between 0 and 1, and
a third group 340, illustrated in FIG. 3 by a rectangle with a dashed line, of two neural network layers comprising, for example, 32 and 2 neurons respectively, the third group 340 taking as an input the output provided by the first group 320 and providing as an output a probability value that the spatio-temporal piece of data, noted 411 for the normal spatio-temporal data and 412 for the abnormal spatio-temporal data, or that the segment, noted 411 for the normal segment and 412 for the abnormal segment, of the spatio-temporal data belongs to a set, also called a “bag”, which is normal 413, i.e. comprising no anomaly, or to a set, also called a “bag”, which is abnormal 414, i.e. comprising at least one anomaly. Furthermore, in one example compatible with the preceding examples, a set is considered abnormal if it comprises at least two abnormal segments or at least two abnormal spatio-temporal data.

A fifth step 150 of the method 100 comprises generating the piece of information of locating the at least one anomaly by the neural network. This piece of information is generated by providing the spatio-temporal piece of data obtained to the neural network in step 130. Thus, at the end of step 150, it is possible to display and/or send this piece of information of locating the at least one anomaly so that this piece of information can be received or viewed by a user. An optional step of displaying or sending the piece of information of locating the at least one anomaly may therefore be included in the method 100. This optional step may enable a user to view this location piece of information in isolation from the spatio-temporal data or in conjunction with the spatio-temporal piece of data. For example, the location piece of information may consist in visually superimposing a visual indication on part of a video, the visual indication making it possible to spatially identify at least one anomaly.

A sixth step 160 of the method 100 comprises obtaining an accuracy score provided by a user. The accuracy score evaluates accuracy of the generated piece of information of locating the at least one anomaly. For example, the accuracy score may consist of a numerical value between 0 and 1. For example, the accuracy score may be 0 when the user considers that the generated piece of information of locating the at least one anomaly is not accurate. For example, an accuracy score with a value of 0 may be provided by a user when:
the method 100 has not located at least one anomaly in a spatio-temporal piece of data comprising at least one anomaly, and/or
the method 100 has located at least one anomaly in a spatio-temporal piece of data comprising no anomaly.

An accuracy score with a value of 1 can be provided by a user when:
the method 100 has located at least one anomaly in a spatio-temporal piece of data comprising at least one anomaly, and/or
the method 100 has not located an anomaly in a spatio-temporal piece of data comprising no anomaly.

Scores between 0 and 1 are also possible, for example:
when the method 100 has located only part of the anomalies included in the spatio-temporal piece of data,
when locating at least one anomaly included in the spatio-temporal piece of data is not optimal, i.e. the spatial and/or temporal location piece of information is not sufficiently accurate.

This accuracy score can be provided by the user by any means enabling the computer to obtain this score. For example, the user can click on a button on a graphical interface displayed by the computer implementing the method 100 or connected to the computer implementing the method 100. The user can also indicate the score using a keyboard on the computer implementing the method 100 or a keyboard on a computer connected to the computer implementing the method 100. It is also possible to deduce the accuracy score from an action by the user. For example, the location piece of information generated in step 130 indicates that no anomaly has been located in the spatio-temporal data but the user performs an action listed as an action to resolve an anomaly, then the accuracy score can automatically be calculated as 0.

A seventh step 170 of the method 100 comprises reinforcement learning the neural network, from the generated piece of information of locating the at least one anomaly and the accuracy score. Thus, from the generated piece of information of locating the at least one anomaly and the accuracy score, it is possible to deduce a value equivalent to a ground truth of locating the at least one anomaly in a spatio-temporal piece of data. For example:
the spatio-temporal piece of data is, in the invention, considered to be abnormal:
   when the generated piece of information of locating the at least one anomaly is equal to 1 and the accuracy score is also equal to 1, or
   when the generated piece of information of locating the at least one anomaly is equal to 0 and the accuracy score is also equal to 0, and
the spatio-temporal piece of data is, in the invention, considered to be normal:
   when the generated piece of information of locating the at least one anomaly is equal to 0 and the accuracy score is equal to 1, or
   when the generated piece of information of locating the at least one anomaly is equal to 1 and the accuracy score is equal to 0.

In machine learning, reinforcement learning consists, for an autonomous agent, in learning the actions to take, based on experiences, so as to optimise a quantitative reward over time. The agent is immersed in an environment and makes decisions based on its current state. In return, the environment provides the agent with a reward, which may be positive or negative. Through iterative experiments, the agent seeks optimal decision-making behaviour, which is a function associating the action to be performed with the current state, in that it maximises the sum of rewards over time. In the method 100, reinforcement learning is performed by optimising a first function penalising a low value of the accuracy score. Stated differently, a high accuracy score is the reward that the agent, i.e. the neural network, maximises over time.

In one example, the seventh step 170 of the method 100 comprises two sub-steps 171 and 172. FIG. 2 is a block diagram illustrating the sub-steps of a step 170 of one example method 100 according to the invention. Sub-step 171 comprises a Markov decision process based reinforcement learning sub-step. The reinforcement learning of this sub-step 171 is performed by optimising a third function reinforcing a temporally anticipated location of the at least one anomaly in the spatio-temporal piece of data. Thus, the third function maximises a temporally anticipated location of the at least one anomaly in an abnormal spatio-temporal piece of data and an anticipated identification of an absence of anomaly in a normal spatio-temporal piece of data. When step 110 has been performed, the third function reinforces location of the at least one anomaly in the first segment or segments of the spatio-temporal piece of data, i.e. in the segment or segments corresponding to the start of the spatio-temporal piece of data. When the neural network is as illustrated in FIG. 3, this piece of information of locating the at least one anomaly can be provided by the third group 340 of the neural network as described previously. One example of a third function called QoP, for “quality of prediction”, is detailed in equation:

$$QoP ( {s}_{t} , {a}_{t} ) = \{ \begin{matrix}1 , & if f ( {ℬ}_{n} ) < 0.5 \\ & or f ( {ℬ}_{p} ) >= 0.5 \\ 0 , & otherwise\end{matrix}$$

With:
[symbol] ₙ for “normal bag”, i.e. a normal spatio-temporal piece of data containing only normal segments, and
[symbol] ₚ for “positive bag”, i.e. an abnormal spatio-temporal piece of data containing one or more abnormal segments.

The third function QoP therefore makes it possible to obtain prediction quality in binary form as a function of the value of a prediction result between 0 and 1.

In one example, compatible with preceding examples, the prediction result during this step 171 is obtained by a function O_{f1} which can be in the form of:

O_{f1}=max_{θ}E_{πθ}TemporalUtility
With:
θ, corresponding to the prediction policy parameters
Π, corresponding to the prediction policy, and
T, corresponding to the trajectory, i.e. the pairs S for “states” and A for “actions”, corresponding to the spatio-temporal data and the prediction scores respectively.

With the TemporalUtility function being in the form of:

$$TemporalUtility ( τ ) = {\sum }_{t = 0}^{T - 1} {γ}^{t} R ( {s}_{t} , {a}_{t} )$$

With:
γ∈[0, 1] and which is an update coefficient that varies the agent depth for anticipation,
R(Sₜ, aₜ), with R the reward and t the discrete time, S, a spatio-temporal piece of data and (s^{t}, sₜ₊₁, . . . , sₜ₊ₙ) the segments of the spatio-temporal piece of data, and a the accuracy score for each segment of the spatio-temporal piece of data.

Sub-step 172 comprises a “Multi Armed Bandit Reinforcement Learning based Multi-Instance Learning”. The reinforcement learning of this sub-step is performed by optimising a fourth function reinforcing multiple location of the at least one anomaly in a spatio-temporal piece of data. Thus, the fourth function rewards a multiple location of at least two anomalies in an abnormal spatio-temporal piece of data and an identification of an absence of anomaly in a normal spatio-temporal piece of data. When step 110 has been performed, the fourth function reinforces, for example, location of the at least one anomaly in a multitude of segments of the spatio-temporal piece of data. When the neural network is as illustrated in FIG. 3, this piece of information of locating the at least one anomaly may be provided by the third group 340 of the neural network as described previously. One example of a fourth function called QoP, for “quality of prediction”, is detailed in the following equation:

$$QoP ( τ ) = \{ \begin{matrix}1 , & if f ( {𝒱}_{n} ) < 0.5 \\ & or ( \text{?} f ( {𝒱}_{p} ) >= 0.5 \\ & and \text{?} f ( {𝒱}_{p} ) >= 0.5 ) \\ 0 , & otherwise\end{matrix}$$

$$\text{?} \text{indicates text missing or illegible when filed}$$

with:
Vₙ representing a normal spatio-temporal piece of data,
Vₚ representing an abnormal spatio-temporal piece of data,
βₚ and βₙ, a set of segments p or n respectively from a normal spatio-temporal piece of data and an abnormal spatio-temporal piece of data, with p≥1 and n≥1.

The fourth QoP function therefore makes it possible to obtain a prediction quality in binary form as a function of the value of a prediction result between 0 and 1.

In one example, compatible with the preceding examples, the prediction result during this step 172 is obtained by a function O_{f2} which may be in the form of:

O_{f2}=max_{θ}E_{πθ}R
With:
θ, the prediction policy parameters
Π, the prediction policy, and
R, the cumulative reward.

Thus, in this step 172, the QoP function returns the value 1:
when, for a normal spatio-temporal piece of data, the generated location piece of information is less than 0.5 for the spatio-temporal piece of data or for all the segments of the normal spatio-temporal piece of data, and
when, for an abnormal spatio-temporal piece of data, the generated location piece of information is greater than 0.5 for the spatio-temporal piece of data or for at least two segments of the normal spatio-temporal piece of data.

In one example, compatible with the preceding examples, functions O_{f1} and O_{f2} can be added to obtain a function O_{f3}. This function O_{f3} therefore makes it possible to take account of temporal coherence, by virtue of function O_{f1}, and spatial coherence, by virtue of function O_{f2}, upon locating the at least one anomaly in a spatio-temporal piece of data. The use of this function O_{f3} is, for example, represented in FIG. 3 by entity 410. The function O_{f3} can therefore be obtained using the following equation:

$${O}_{f 3} = {O}_{f 1} + {O}_{f 2}$$

An eighth step 180 of the method 100 comprises similarity learning the neural network previously reinforcement learned in step 170. Similarity learning, also known as metric learning, makes it possible to measure the degree of similarity between two elements in a same set. The general idea of similarity learning is to learn metrics that allow data of a same class to be contained together and different data to be dissociated. The aim is therefore to minimise the pairwise constraint. Unlike conventional supervised learning, which annotates each instance with a class label, a pairwise constraint is given for all the data. This is divided into two sets, the equivalence constraint, which gathers pairs of semantically similar data that must be close to the learned metric, and the inequivalence, i.e. non-equivalence, constraint, which gathers pairs of semantically dissimilar data that must be far from each other. Next, a regression model is used to estimate the probability of two data belonging to the same class. It is possible to note that this regression is possible via the reinforcement learning algorithm and that this score makes it possible to know whether the data are similar or different.

This step 180 can be performed for each new spatio-temporal piece of data or only when a predetermined number of spatio-temporal data have been used and recorded, for example used in the preceding steps of method 100. This step 180 is performed from a first set of spatio-temporal data comprising the spatio-temporal piece of data obtained in step 130. When the neural network is as illustrated in FIG. 3, this step 180 can be performed using the data output by the second group 330 of the neural network as described previously. Similarity learning is performed by minimising a second function. This second function tends to optimise compliance with a pairwise constraint between the spatio-temporal piece of data obtained 130 and at least one other spatio-temporal piece of data of the first set of spatio-temporal data. Each spatio-temporal piece of data in the first set of spatio-temporal data comprises a ground truth piece of information of locating the at least one anomaly obtained from the generated piece of information of locating the at least one anomaly in the spatio-temporal piece of data and from the accuracy score. This a ground truth piece of information can, for example, be obtained using the same method as the ground truth equivalent value that can be obtained in step 170. The first set of spatio-temporal data may comprise spatio-temporal data obtained prior to the method 100. This spatio-temporal data may, for example, come from a set of spatio-temporal data used during initially training the neural network. Alternatively or complementarily, the first set of spatio-temporal data may comprise spatio-temporal data obtained during the method 100, which corresponds to the production phase of the neural network. For example, the first set of spatio-temporal data may comprise part or all of the data recorded during the production phase of the neural network. Thus, each time spatio-temporal piece of data is obtained in step 130, this piece of data can be recorded so that it can be added to the first data set for subsequent iterations of the method 100. Stated differently, at each implementation of the method 100, the spatio-temporal piece of data can be added at the end of step 180 to a first set of spatio-temporal data which can be stored and reused for subsequent implementations of the method 100. The number of data in the first set of spatio-temporal data can therefore increase as the method 100 is used in production. Furthermore, it is also possible for spatio-temporal data added to the first set of spatio-temporal data to replace spatio-temporal data in the first set of spatio-temporal data so that the size of the first set of spatio-temporal data remains stable. In addition, it is beneficial for the first set of spatio-temporal data to comprise normal and abnormal spatio-temporal data in equivalent or relatively equivalent proportions. For example, it is beneficial for the first set of spatio-temporal data to comprise between 30% and 70% normal spatio-temporal data. In one example, compatible with the preceding examples, a compatible function for similarity learning in step 180 is as follows:

$${max}_{i ∈ {ℬ}_{p}} E ( {𝒱}_{p}^{i} ) > {max}_{i ∈ {ℬ}_{n}} E ( {𝒱}_{n}^{i} )$$

With:
Vₚⁱ representing an index i segment of an abnormal spatio-temporal piece of data Vₚ,
Vₙⁱ representing an index i segment of a normal spatio-temporal piece of data Vₙ,
βₚ and βₙ, a set of segments p or n respectively from a normal spatio-temporal piece of data and an abnormal spatio-temporal piece of data, with p≥1 and n≥1, and

This function allows metric learning for the first set of spatio-temporal data with a view to locating at least one anomaly, even when the spatio-temporal data have not been annotated with a location piece of information.

In one example, compatible with the preceding examples, a compatible function for similarity learning of step 180 is as follows:

$$E ( arg {max}_{i ∈ {ℬ}_{p}} f ( {𝒱}_{p}^{i} ) ) > E ( arg {max}_{i ∈ {ℬ}_{n}} f ( {𝒱}_{n}^{i} ) )$$

This function is used especially to identify the segment of an abnormal spatio-temporal piece of data corresponding to the highest anomaly score. Indeed, the segment with the highest anomaly score of an abnormal spatio-temporal piece of data is the most likely to be the true positive instance, i.e. the abnormal segment. It is possible to note that, for a normal spatio-temporal piece of data, the segment with the highest anomaly score is the one which most resembles an abnormal segment but which is in fact normal. This segment with the highest anomaly score in a normal piece of data can generate a false alarm in anomaly location. Thus, using similarity learning, it is possible to:
move abnormal segments with the highest anomaly score away from normal segments.
bring normal segments closer together, especially normal segments with the highest anomaly score and normal segments with a lower anomaly score.

In order to classify segments by similarity, a triplet loss function can be used. Such a function is represented in FIG. 3 by the entity 420. For example, a function such as the following can be used:

$$ℒ ( A , P , N ) = max ( {‖ A - P ‖}^{2} - {‖ A - N ‖}^{2} + 1 , 0 )$$

With:
A:E( [symbol] ₙ) or E(arg [symbol] f( [symbol] ₙⁱ))
P:E(arg [symbol] f( [symbol] ₙⁱ))
N:E(arg [symbol] f( [symbol] ₚⁱ))
wherein A is the current segment which may be normal or abnormal, P, for “positive”, is a segment of the same class as the current segment A, i.e. a normal segment if the current segment A is normal and an abnormal segment if the current segment A is abnormal, and N, for “negative”, is a normal segment of a different class from the current segment A, i.e. an abnormal segment if the current segment A is normal and a normal segment if the current segment A is abnormal.

An optional ninth step 190 of the method 100 consists in modifying the real environment in which one or more anomalies have been located using the preceding steps of the method 100. For example, step 190 may comprise the following actions:
automatically or manually stopping a manufacturing or maintenance operation on a manufactured piece, for example on an aircraft, and/or
issuing an alert signal in the real environment, for example to warn of an immediate danger, and/or
evacuating a zone in the real environment, and/or
identify one or more persons behaving in a risky or dangerous manner.

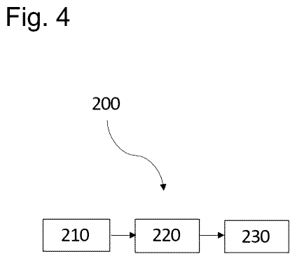

An aspect of the invention also relates to a method for initial learning the neural network. FIG. 4 is a block diagram illustrating the steps of one example method 200 of initially learning the neural network according to the invention. The term “initial learning” is used in the present application simply to distinguish this learning method 200 from the learning phases of method 100. Method 200 is a method for learning a neural network configured to take as an input a spatio-temporal piece of data and to provide as an output a piece of information of locating at least one anomaly in said spatio-temporal piece of data. For example, a neural network compatible with method 100 can be learned by the method 200.

A first step 210 of the method 200 comprises reinforcement learning the neural network. This step 210 is performed from a second set of spatio-temporal data previously obtained. The second set of spatio-temporal data is a set of weakly annotated data, i.e. each spatio-temporal piece of data is annotated only with a piece of information of the presence and/or absence of at least one anomaly in a spatio-temporal piece of data. This set of spatio-temporal data may, for example, be a publicly available set of spatio-temporal data such as the data set known as “UCF Crime”. The UCF Crime data set was introduced by Sultani. W, Chen C. and, Mubarak S. in “Real-world Anomaly Detection in Surveillance Videos”, 2018. Reinforcement learning the neural network is performed by optimising a fifth function penalising a difference, for each spatio-temporal piece of data of the second set of spatio-temporal data, between the generated piece of information of locating the at least one anomaly for said each spatio-temporal piece of data generated by the neural network and the ground truth piece of information of said each spatio-temporal piece of data.

This step 210 is similar to step 170 of method 100 with the exception that the data used in step 210 comes from a second data set comprising weakly annotated spatio-temporal data. Thus, all the examples provided for step 170 are also compatible with step 210.

A second step 220 of the method 200 comprises generating subsets of spatio-temporal data from the second set of spatio-temporal data. During this step, the second set of spatio-temporal data is divided into several subsets so that each subset of spatio-temporal data comprises at least one abnormal spatio-temporal piece of data and at least one normal spatio-temporal piece of data. For example, it is beneficial for each subset of spatio-temporal data to comprise between 30% and 70% normal spatio-temporal data.

A third step 230 of the method 200 comprises similarity learning the neural network. Similarity learning the neural network is performed for each spatio-temporal piece of data of each subset of spatio-temporal data generated in step 220. Similarity learning the network is performed by optimising a sixth function penalising a pairwise constraint between said each spatio-temporal piece of data and at least one other spatio-temporal piece of data of said each subset of spatio-temporal data.

This step 230 is similar to step 190 of the method 100 with the exception of the data used. Thus, all of the examples provided for step 180 are also compatible with step 230.

In one example, compatible with the preceding examples, obtaining 140 the neural network comprises the method 200 for initially learning the neural network.

It will be appreciated that the present invention addresses a technological problem inherent in prior art methods of locating anomalies in spatio-temporal data. Specifically, conventional techniques struggle with adaptability to new environments and types of anomalies, are constrained by the need for extensively annotated datasets, and lack the capacity for real-time learning during deployment. One or more aspects of the invention offers a concrete, technical solution by enabling reinforcement and similarity learning during the production phase, leveraging user-provided accuracy feedback and spatio-temporal metric optimization. This approach fundamentally enhances the neural network's ability to adapt dynamically to novel inputs and environments, addressing a key deficiency in traditional anomaly detection systems.

One or more aspects of the disclosed invention implement a hybrid machine learning framework, combining reinforcement learning with Markov decision processes and multi-instance learning, as well as metric-based similarity learning. These elements are executed in a manner tightly integrated with the processing and analysis of spatio-temporal data, such as video, sound, or sensor-derived measurements. The method's technical architecture includes modular neural network components tailored to extract, compress, and process spatial and temporal features of data, achieving granular and robust anomaly detection. This specific implementation directly addresses technical challenges related to both scalability and real-time anomaly location.

Aspects of the invention provide numerous technological benefits that transcend abstract concepts:

Enhanced Efficiency: The reinforcement learning module iteratively improves the network's accuracy using real-time user feedback, ensuring high adaptability without requiring retraining from scratch.

Scalability: The similarity learning module optimizes the system's capacity to process large datasets with minimal annotation, reducing computational burdens compared to conventional neural network training methods.

Practical Application: The method facilitates actionable anomaly detection in critical systems, including aerospace, healthcare, and public safety, enabling proactive responses to detected irregularities.

Real-Time Adaptation: The system dynamically evolves during production, offering a transformative capability for real-time anomaly detection in previously unseen environments.

Aspects of the invention do not merely embody abstract ideas but are rooted in practical, technological processes that manipulate spatio-temporal data to produce a specific, useful result: accurate and efficient anomaly detection. The method employs specific algorithms, data structures, and computational architectures to transform raw spatio-temporal input data into meaningful, actionable information. These operations are inseparable from the underlying hardware and computational systems required to implement the method.

The technological advancements enabled by aspects of the invention are applicable across a wide array of industries, including, for example,
Aerospace: analyzing vibration and force data to detect anomalies in engine performance.
Healthcare: monitoring EEG and ECG data to identify and locate physiological anomalies.
Public Safety: enhancing surveillance systems to pinpoint and address irregular activities in real time.
Transportation: improving diagnostics and maintenance systems for vehicles and infrastructure.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

As used herein in the specification and in the claims, the phrase “at least one”, in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

A person skilled in the art will readily appreciate that various features, elements, parameters disclosed in the description may be modified and that various embodiments disclosed may be combined without departing from the scope of the invention. For example, various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Having described above several aspects of at least one embodiment, it is to be appreciated various alterations, modifications, and improvements will readily occur to those skilled in the art. Such alterations, modifications, and improvements are intended to be aspects of this disclosure. Accordingly, the foregoing description and drawings are by way of example only.

1. A computer-implemented method for locating at least one anomaly in a spatio-temporal piece of data, the method comprising:
obtaining a spatio-temporal piece of data,
obtaining a neural network configured to generate a piece of information of locating at least one anomaly from a spatio-temporal piece of data,
generating, by the neural network obtained, the piece of information of locating the at least one anomaly by providing the spatio-temporal piece of data obtained to the neural network,
obtaining an accuracy score provided by a user evaluating an accuracy of the generated piece of information of locating the at least one anomaly,
reinforcement learning the neural network, from the generated piece of information of locating the at least one anomaly and from the accuracy score, reinforcement learning being performed from a first function penalising a low value of the accuracy score,
similarity learning the neural network reinforcement learned, from a first set of spatio-temporal data comprising the spatio-temporal piece of data obtained, similarity learning being performed from a second function to be minimised, the second function corresponding to a pairwise constraint between the spatio-temporal piece of data obtained and at least one other spatio-temporal piece of data of the first set of spatio-temporal data, the first set of spatio-temporal data comprising, for each spatio-temporal piece of data of the first set of spatio-temporal data, a ground truth piece of locating the at least one anomaly obtained from the generated piece of information of locating the at least one anomaly in the spatio-temporal piece of data and from the accuracy score.

2. The method according to claim 1, wherein reinforcement learning the neural network comprises a Markov decision process based reinforcement learning sub-phase and a multi armed bandit reinforcement learning based multi-instance learning.

3. The method according to claim 2, wherein the Markov decision process based reinforcement learning sub-phase is performed from a third function reinforcing anticipated location of the at least one anomaly in the spatio-temporal piece of data.

4. The method according to claim 2, wherein the multi armed bandit reinforcement learning based multi-instance learning is performed from a fourth function reinforcing multiple location of the at least one anomaly in the spatio-temporal piece of data.

5. A method for initially learning a neural network taking as an input a spatio-temporal piece of data and providing as an output a piece of information of locating at least one anomaly in said spatio-temporal piece of data, the method comprising:
reinforcement learning the neural network, from a second set of weakly annotated spatio-temporal data, each spatio-temporal piece of data of the second set of spatio-temporal data being annotated with a ground truth piece of information of the presence and/or absence of the at least one anomaly in said each spatio-temporal piece of data, reinforcement learning the neural network being performed from a fifth function penalising a difference, for each spatio-temporal piece of data of the second set of spatio-temporal data, between the generated piece of information of locating the at least one anomaly for said each spatio-temporal piece of data generated by the neural network and the a ground truth piece of information of said each spatio-temporal piece of data,
generating, from the second set of spatio-temporal data, sub-sets of spatio-temporal data, each sub-set of spatio-temporal data comprising at least one spatio-temporal piece of data with at least one anomaly and at least one spatio-temporal piece of data with no anomaly, and
similarity learning the neural network, for each spatio-temporal piece of data of each subset of spatio-temporal data, similarity learning the neural network from a sixth function penalising a pairwise constraint between said each spatio-temporal piece of data and at least one other spatio-temporal piece of data of said each subset of spatio-temporal data.

6. The method according to claim 1, wherein obtaining the neural network comprises initially training the neural network.

7. The method according to claim 1, wherein the spatio-temporal piece of data is:
a video, and/or
a sound, and/or
a piece of data derived from a measurement of force and/or vibration and/or temperature and/or pressure and/or brightness.

8. A non-transitory computer program product comprising instructions which, when the program is executed by a computer, cause the program to implement the method according to claim 1.

9. A non-transitory computer-readable recording medium comprising instructions which, when executed by a computer, cause the instructions to implement the method according to claim 1.

10. A system comprising a device adapted to perform the method according to claim 1.
